(19) United States
(12) Patent Application Publication
(10) Pub. No.: US 2005/0173939 A1
(43) Pub. Date: Aug. 11, 2005

(54) Self-compensating latch for striker variation

(76) Inventor: Jeffery T. Bonk, Clinton Township, MI (US)

Correspondence Address: HARNESS, DICKEY & PIERCE, P.L.C., P.O. BOX 828, BLOOMFIELD HILLS, MI, 48303, US

(21) Appl. No.: 10/772,570

(22) Filed: Feb. 5, 2004

(51) Int. Cl. B60N 2/02

(52) U.S. Cl. 296/65.05

(57) ABSTRACT

A floor latch apparatus for a vehicle seat is provided. The floor latch apparatus includes a housing member, a locking member, an engaging member, and a biasing member. The locking member includes a locking portion and a claw portion and is supported on the housing member for rotational displacement about a first axis. The engaging member includes an engaging portion supported on the housing member for rotational displacement about a second axis, which is substantially parallel to the first axis. The biasing member is disposed between the locking member and the engaging member and is adapted to bias the locking portion into engagement with the engaging portion in at least one plane substantially common with the first axis. This produces at least one force vector acting on the engaging member through a point located between the first and second axes.

### FIELD OF THE INVENTION

The present invention relates to a vehicle floor latch apparatus, and more particularly, to a self-compensating vehicle floor latch apparatus.

### BACKGROUND OF THE INVENTION

Vehicle floor latch apparatuses are incorporated into vehicle seats to selectively access an area behind the seat. Most floor latch apparatuses have a locking feature, which independently locks the vehicle seat to a selected portion of the vehicle body. The locking feature further enables a user to manually unlock the apparatus. In the unlocked position, a user may freely move or pivot the seat to obtain access to the area behind the seat. In the locked position, a conventional vehicle floor latch apparatus includes locking member, such as a claw, in locking engagement with a striker pin. A spring member is included to bias the locking member into an engaging member, such as a pawl, to maintain this locking engagement. Disposed on both the locking member and the engaging member are a plurality of teeth. The spring member causes the teeth on the locking member to exert forces on the teeth on the engaging member. However, the teeth are designed such that the forces tend, to bias the engaging member out of engagement with the locking member, thus, unsuspectingly disengaging the locking member from the striker pin. This creates an unsafe environment for the vehicle passengers. Therefore, a cam mechanism has been typically disposed behind the engaging member to combat the forces tending to disengage the locking member.

### SUMMARY OF THE INVENTION

A floor latch apparatus for a vehicle seat is provided. The floor latch apparatus includes a housing member, a locking member, an engaging member, and a biasing member. The locking member includes a locking portion and a claw portion and is supported on the housing member for rotational displacement about a first axis. The engaging member includes an engaging portion supported on the housing member for rotational displacement about a second axis, which is substantially parallel to the first axis. The biasing member is disposed between the locking member and the engaging member and is adapted to bias the locking portion into engagement with the engaging portion in at least one plane substantially common with the first axis. This produces at least one force vector acting on the engaging member through a point located between the first and second axes.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a locked vehicle floor latch apparatus in accordance with the present invention;

FIG. 2 is a partial side view of the vehicle floor latch of FIG. 1;

FIG. 3 is a side view of an unlocked vehicle floor latch apparatus in accordance with the present invention;

FIG. 4 is a side view of an engaged vehicle seat in accordance with the present invention; and

FIG. 5 is a side view of a disengaged vehicle seat in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

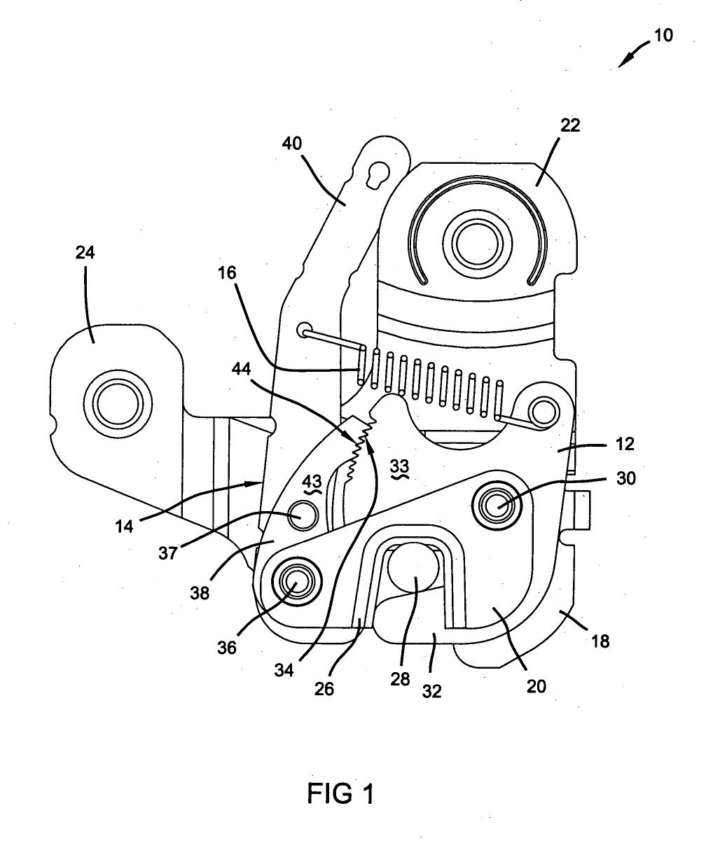

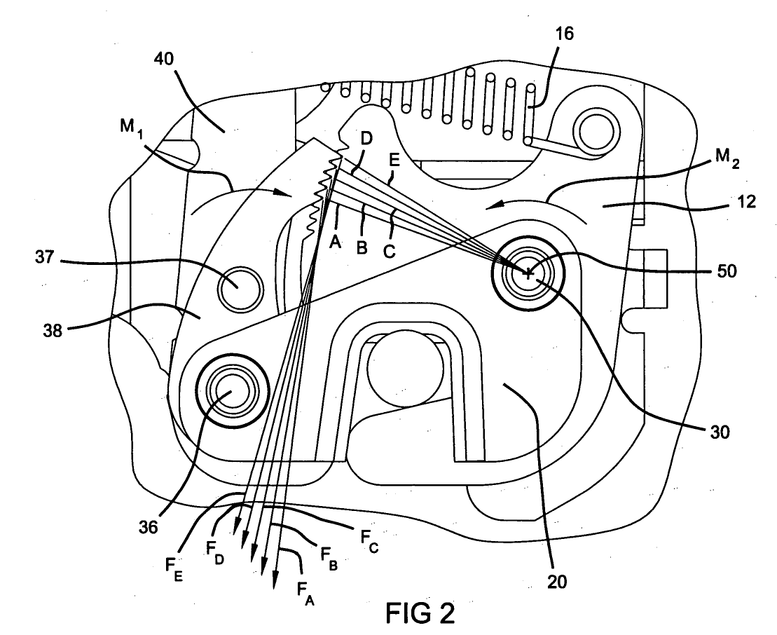

FIGS. 1 and 2 illustrate an exemplary embodiment of a vehicle floor latch apparatus 10 of the present invention in the locked position. The floor latch apparatus 10 includes a housing, a locking member 12, an engaging member 14, and a biasing member 16. The housing includes a first metal plate 18 and a second metal plate 20. The first metal plate 18 includes first and second flanges 22, 24 for attaching the apparatus 10 to a vehicle seat. The second metal plate 20 includes a U-shaped portion 26 for receiving a striker pin 28. The locking member 12 is supported for rotational displacement on a first pin 30 disposed within the housing. The locking member 12 includes a claw portion 32 and a locking portion 33. The claw portion 32 engagingly locks a striker pin 28. The locking portion 33 includes a first plurality of teeth 34.

The engaging member 14 is supported for rotational displacement on a second pin 36 disposed within the housing. The engaging member 14 includes a pawl portion 38 and a lever portion 40 fixed together by a rivet 37. The pawl portion 38 includes an engaging portion 43, which includes a second plurality of teeth 44 in locking engagement with the first plurality of teeth 34. The biasing member 16 includes a coil spring disposed between the locking member 12 and the lever portion 40 of the engaging member 14.

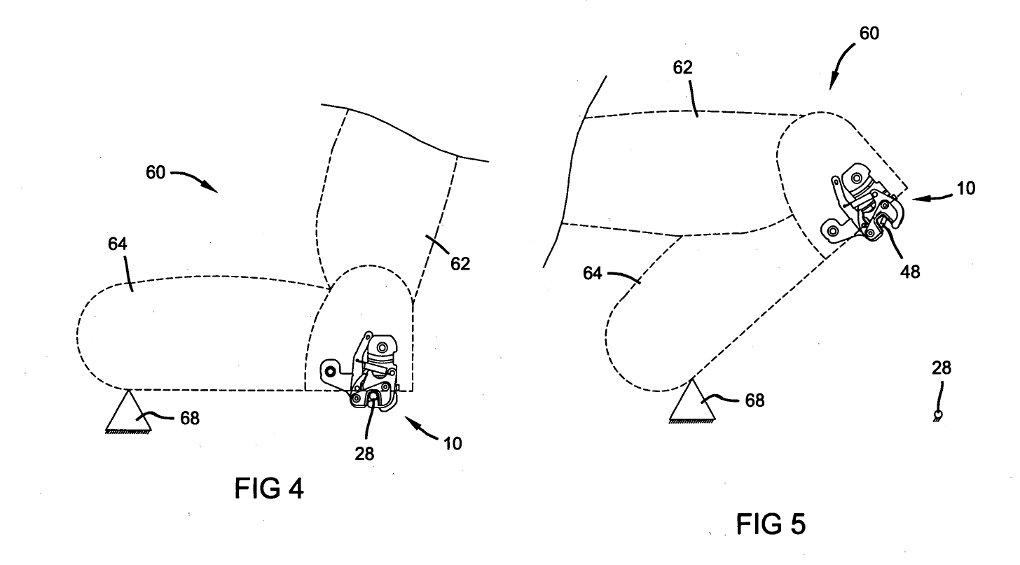

The biasing member 16 biases the first plurality of teeth 34 on the locking member 12 into engagement with the second plurality of teeth 44 on the engaging member 14. In an exemplary embodiment, the first plurality of teeth 34 includes more individual teeth than the second plurality of teeth 44. This allows for ratcheting engagement of the locking and engaging members 12, 14 to accommodate slight variations in the position of the striker pin 28 along the engaging path of the apparatus 10. For example, in an exemplary embodiment shown in FIGS. 4 and 5, the apparatus 10 is located on the bottom of a passenger seat 60 and the striker pin 28 is fixed to the vehicle floor panel. In this configuration, the ratcheting engagement enables the apparatus to accommodate variations in the vertical position of the striker pin 28. In an alternative exemplary embodiment, the apparatus 10 might be located on the back of a vehicle seat 60 for enabling access to a storage compartment and the striker pin 28 might be located under a package shelf. In this configuration, the ratcheting engagement enables the apparatus 10 to accommodate variations in the horizontal position of the striker pin 28. It should be appreciated that while only two configurations for the apparatus 10 have been described, other configurations are intended to be within the scope of the present invention.

FIG. 2 illustrates, in detail, the engaging relationship between the first and second pluralities of teeth 34, 44. Engagement between each of the teeth occurs in one of a plurality of planes A, B, C, D, and E. Planes A, B, C, D, and E each extend substantially through the rotational axis 50 of the locking member 12, which is located generally axially through the first pin 30. This causes the first plurality of teeth 34 to exert forces F_{A}, F_{B}, F_{C}, F_{D}, and F_{E} on the second plurality of teeth 44 through planes A, B, C, D, and E, respectively. The plurality of forces F_{A}, F_{B}, F_{C}, F_{D}, and F_{E} act through points located between the first pin 30 and the second pin 36. Therefore, a clockwise moment M₁ acts on the engaging member 14 and a counter-clockwise moment M₂ acts on the locking member 12. These competing moments combine to independently maintain engagement of the locking and engaging members 12, 14. To unlock the apparatus, the lever portion 40 of the engaging member 14 is pivoted counter-clockwise. This causes the second plurality of teeth 44 to disengage the first plurality of teeth 34, thereby enabling the biasing member 16 to further bias the locking member 12 in the counter-clockwise direction.

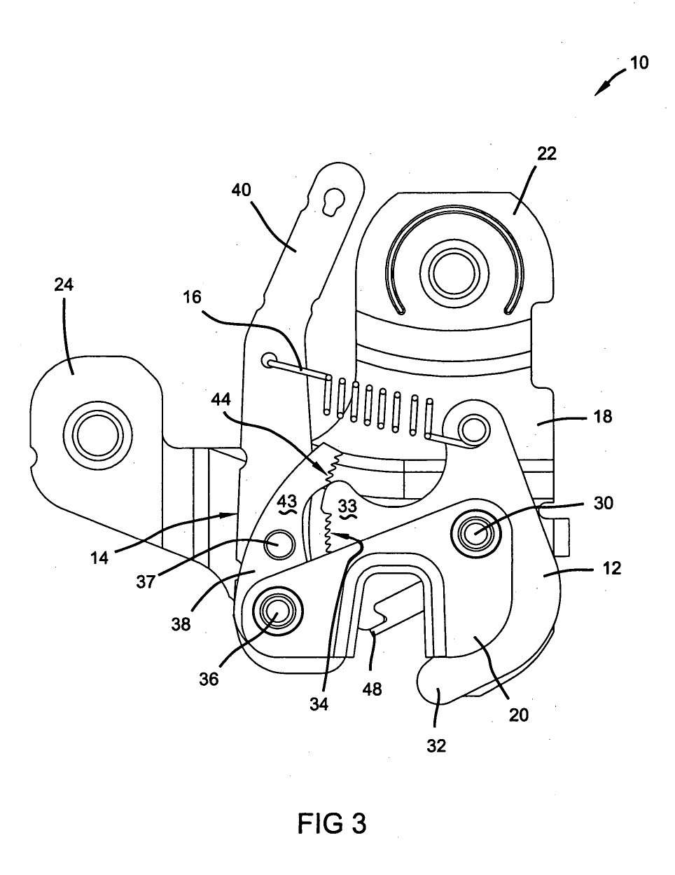

FIG. 3 illustrates an exemplary embodiment of a vehicle seat floor latch apparatus 10 of the present invention in the unlocked position. The engaging member 14 has been pivoted, via the lever portion 40, counterclockwise about the second pin 36. Tension on the biasing member 16 causes the locking member 12 to pivot in the counterclockwise direction about the first pin 30. The claw portion 32 of the locking member 12, therefore, is disengaged from the striker pin 28 and the entire apparatus 10 has been removed therefrom. This exposes a thrust surface 48 on the periphery of the locking member 12.

FIGS. 4 and 5 illustrate a vehicle seat 60 including a vehicle seat floor latch apparatus 10 in accordance with the present invention. The vehicle seat 60 includes a seat back 62 pivotally coupled to a seat bottom 64. The seat bottom 64 is pivotally supported on a pivot assembly 68.

The vehicle seat floor latch apparatus 10, as described above, includes a housing, a locking member 12, an engaging member 14, and a biasing member 16. The engaging member includes a lever portion 40. The lever portion 40 is manipulated to disengage the floor latch apparatus 10. This enables the vehicle seat to pivot upwardly on the pivot assembly 68, as shown in FIG. 5. To re-engage the floor latch apparatus 10, the vehicle seat 60 is pivoted downward on the pivot assembly 68 and dropped onto the striker pin 28. The thrust surface 48 of the locking member 12, shown in detail in FIG. 3, contacts the striker pin 28 and forces the locking member 12 to rotate clockwise, thereby causing the claw portion 32 of the locking member 12 to engage the striker pin 28. When the locking member 12 ceases to rotate, the biasing member 16 biases the first plurality of teeth 34 into ratcheting engagement with the second plurality of teeth 44. The first plurality of teeth 34 exert a force on the second plurality of teeth 44 that independently maintain the apparatus 10 in the locked position, as discussed above with reference to FIG. 2.

The description of the invention is merely exemplary in nature and, thus, variations that do not depart from the gist of the invention are intended to be within the scope of the invention. Such variations are not to be regarded as a departure from the spirit and scope of the invention.

1. A floor latch apparatus for a vehicle seat comprising:
a housing member;
a locking member having a locking portion supported on said housing member for rotational displacement about a first axis;
an engaging member having an engaging portion supported on said housing member for rotational displacement about a second axis substantially parallel to said first axis; and
a biasing member disposed between said locking member and said engaging member adapted to bias said locking portion into engagement with said engaging portion in at least one plane substantially common with said first axis to produce at least one force acting on said engaging member through a point located between said first and second axes.

2. The apparatus of claim 1, wherein said locking and engaging portions include first and second engaging faces, respectively, engaged in said plane.

3. The apparatus of claim 1, wherein said locking and engaging portions include a plurality of asymmetrical teeth.

4. The apparatus of claim 1, further comprising a striker pin disposed on said housing member adapted to be selectively engaged by a claw portion of said locking member.

5. The apparatus of claim 1, wherein said engaging member includes a pawl portion for being engaged by said locking member and a lever portion for actuating said apparatus.

6. The apparatus of claim 5, wherein said biasing member is a coil spring having one end attached to said lever portion and another end attached to said locking member.

7. The apparatus of claim 1, wherein said locking portion includes a first plurality of teeth and said engaging portion includes a second plurality of teeth lesser in number than said first plurality of teeth such to provide for ratcheting engagement therebetween.

9. A floor latch apparatus for a vehicle seat comprising:
a housing;
a locking member having a first plurality of teeth supported on said housing for rotational displacement about a first axis;
an engaging member having a second plurality of teeth supported on said housing for rotational displacement about a second axis substantially parallel to said first axis; and
a biasing member disposed between said locking member and said engaging member adapted to bias said first and second pluralities of teeth into engagement in a plane substantially common with said first axis to exert a force acting on said engaging member through a point located between said first and second axes.

10. The apparatus of claim 9, further comprising a striker pin disposed on said housing member for being selectively engaged by a claw portion of said locking member.

11. The apparatus of claim 9, wherein said engaging member includes a pawl portion for being engaged by said locking member and a lever portion for actuating said apparatus.

12. The apparatus of claim 9, wherein said first and second pluralities of teeth include asymmetrical teeth.

13. The apparatus of claim 9, wherein said first plurality of teeth includes a greater number of teeth than said second plurality of teeth such to provide for ratcheting engagement therebetween.

14. The apparatus of claim 9, wherein said locking member applies a force to said engaging member through a point located between said first and second axes for maintaining engagement of said locking and engaging members.

15. The apparatus of claim 11, wherein said biasing member includes a coil spring having one end attached to said lever portion and another end attached to said locking member.

16. A vehicle seat assembly for a flip-type seat comprising:
a seat pivotally coupled to a vehicle;
a striker pin fixed to said vehicle; and
a latch attached to said seat for selectively engaging said striker pin to restrict pivotal movement of said seat;
said latch including a housing member, a locking member having a locking portion and supported on said housing member for rotational displacement about a first axis, an engaging member having an engaging portion and supported on said housing member for rotational displacement about a second axis substantially parallel to said first axis, and a biasing member disposed between said locking member and said engaging member adapted to bias said locking portion into engagement with said engaging portion in at least one plane substantially common with said first axis to produce at least one force acting on said engaging member through a point located between said first and second axes.

17. The assembly of claim 16, wherein said locking and engaging portions include first and second engaging faces, respectively, engaged in said plane.

18. The assembly of claim 16, wherein said locking and engaging portions include a plurality of asymmetrical teeth.

19. The assembly of claim 16, further comprising a striker pin disposed on said housing member adapted to be selectively engaged by a claw portion of said locking member.

20. The assembly of claim 16, wherein said engaging member includes a pawl portion for being engaged by said locking member and a lever portion for actuating said apparatus.

21. The assembly of claim 20, wherein said biasing member is a coil spring having one end attached to said lever portion and another end attached to said locking member.

22. The assembly of claim 16, wherein said locking portion includes a first plurality of teeth and said engaging portion includes a second plurality of teeth lesser in number than said first plurality of teeth such to provide for ratcheting engagement therebetween.

23. The assembly of claim 16, wherein said biasing member is a coil spring.

24. A vehicle seat assembly for a flip-type seat comprising:
a seat pivotally coupled to a vehicle;
a striker pin fixedly attached to said vehicle; and
a latch attached to said seat for selectively engaging said striker pin to restrict pivotal movement of said seat;
said latch including a housing, a locking member having a first plurality of teeth and supported on said housing for rotational displacement about a first axis, an engaging member having a second plurality of teeth and supported on said housing for rotational displacement about a second axis substantially parallel to said first axis, and a biasing member disposed between said locking member and said engaging member adapted to bias said first and second pluralities of teeth into engagement in a plane substantially common with said first axis.

25. The assembly of claim 24, further comprising a striker pin disposed on said housing member for being selectively engaged by a claw portion of said locking member.

26. The assembly of claim 24, wherein said engaging member includes a pawl portion for being engaged by said locking member and a lever portion for actuating said apparatus.

27. The assembly of claim 24, wherein said first and second pluralities of teeth include asymmetrical teeth.

28. The assembly of claim 24, wherein said first plurality of teeth includes a greater number of teeth than said second plurality of teeth such to provide for ratcheting engagement therebetween.

29. The assembly of claim 24, wherein said locking member applies a force to said engaging member through a point located between said first and second axes for maintaining engagement of said locking and engaging members.

30. The assembly of claim 26, wherein said biasing member includes a coil spring having one end attached to said lever portion and another end attached to said locking member.
